(19) United States
(12) Patent Application Publication
(10) Pub. No.: US 2012/0230390 A1
(43) Pub. Date: Sep. 13, 2012

(54) Adaptive Control of Encoders for Continuous Data Streaming

(76) Inventor: Gun Akkor, Philadelphia, PA (US)

(21) Appl. No.: 13/042,997

(22) Filed: Mar. 8, 2011

(51) Int. Cl. H04N 7/40

(52) U.S. Cl. 375/240.02; 375/E07.127

(57) ABSTRACT

Active control of the output bit-rate of a system of constant bit-rate encoders is provided to match their aggregate bit-rate to the available network bit-rate of a communication channel over which a packetized data stream is to be transmitted. Cross-layer optimization is achieved between network layer performance metrics, such as queue size, round-trip-time delay, and available bit-rate, and application layer requirements of the data encoders, such as output bit-rate, input frame-rate, and packet loss, through a tight coupling of these parameters. Complex run-time calculations or heavy network probing are avoided while achieving the beneficial results, which is advantageous in systems that deal with real-time applications, such as live video streaming for video surveillance and security.

### BACKGROUND

In the field of communication, data encoding allows data to be reformatted or converted into a representative code so that information can be transmitted over a communication channel by way of a reduced amount of data. Video encoders, for example, are used to compress and packetize video data generated by one or more data sources into a network bit stream suitable for transmission over a digital communication channel. A constant bit-rate (CBR) video encoder allocates a fixed number of bits per second to the encoding of a video frame at a given resolution, but compensates for high motion-content or complexity in the captured video scene, which would otherwise force the encoder to exceed its bit-rate, by reducing the image quality of the encoded video stream, such as by coarse quantization of the captured video frames. A variable bit-rate (VBR) video encoder, on the other hand, dynamically varies the number of bits per second allocated to the encoding of a video frame at a given resolution in order to maintain a constant level of video quality and frame-rate as the motion content or the complexity of the video scene varies. Whereas, VBR encoders are a common choice for encoding of digital storage media, such as DVD disks, CBR encoders are preferred for transmission over digital communication channels, since they give the system engineer a tighter control over the output bit-rate in light of the bit-rate capacity of the channel over which the video stream is to be transmitted. Since a higher video bit-rate translates into a higher perceived video quality, it is desirable to set this value to the maximum that can be accommodated by the underlying digital communication channel.

When the bit-rate capacity of the digital channel is not known in advance, a conservative setting would cause unnecessarily poor video quality, whereas, a higher setting would exceed the available capacity in the network and cause overflowing of transmission buffers. The latter, in turn, would also result in poor video quality due to excessive packet loss. The problem becomes more pronounced when the capacity for a communication channel is not only unknown in advance, but also varies in time. Such time varying channels are particularly common in wireless communication where the network bit-rate available to the users depends on, among other things, geographical location of the user within the coverage area of the wireless network, the sophistication and efficiency of the infrastructure deployed by the service provider, and the number of users competing for available resources. Even as new wireless technologies make higher bit-rates available, they are increasingly met with a pool of new mobile and portable devices that stream and download video content thereby limiting the share of network capacity available to a particular user.

Increasingly, the need has been felt for active control CBR encoders, such as CBR video encoders, so that the aggregate bit-rate thereof can be accommodated in temporally-varying availability of bandwidth for a communication channel over which the video stream is to be transmitted.

### SUMMARY

The present general inventive concept is directed to adaptively controlling the output bit-rate of a system of one or more application level encoders so that the aggregate bit-rate of all such encoders can be accommodated in a temporally-varying limitations on bandwidth for a communication channel over which the data stream is to be transmitted.

The foregoing and other utility and advantages of the present general inventive concept may be achieved by an encoding apparatus that encodes a sequence of data structures for transmission to a remote location. A network interface may transmit a plurality of packets to a communication network in accordance with a network communication protocol. Each of the network packets contain an independent number of segments of an encoded bitstream. An adapter estimates a capacity in the communication network from locally obtained network performance indicators and generates encoding parameters associated with the estimated capacity such that the segments of the encoded bitstream are distributed across the network packets to meet predetermined requirement for delivery at the remote location. An encoder encodes the data structures in accordance with the encoding parameters to generate a constant bit-rate bitstream therefrom such that the segments are in the distribution across the packets at the network interface.

The foregoing and other utility and advantages of the present general inventive concept may also be achieved by an encoding apparatus that encodes video data generated at a local location for transmission through a communication network to a remote location. A network interface transmits network packets compliant with a network communication protocol. Each of the network packets contains an independent number of segments of an encoded video data stream. A rate controller estimates an available capacity in the communication network from at least one locally obtained network performance indicator within which the network packets are transmittable to the remote location. The rate controller generates an encoding parameter by which the encoded bitstream generated in accordance therewith produces the segments of the video data stream that are distributed across the network packets to meet predetermined delivery requirements. A video encoder set encodes the video data into a constant bit-rate bitstream in accordance with the encoding parameters provided thereto such that the segments thereof are in the distribution across the packets at the network interface.

The foregoing and other utility and advantages of the present general inventive concept may also be achieved by a machine implemented method for encoding structured data at a local location for transmission over a communication network to a remote location. Values are assigned to encoding parameters to correspond to values of an estimated network data capacity. The assigned values of the encoding parameters are such that segments of an encoded bitstream encoded in accordance therewith are distributed across respective network packets compliant with a network communication protocol to meet predetermined delivery requirements at the remote location. Network performance indicators indicative of data throughput in the communication network are determined and the value of the network data capacity estimated from the network performance indicators. The values of the encoding parameters corresponding to the value of the estimated network capacity are retrieved and the structured data are encoded at a constant data rate corresponding to the encoding parameters.

### BRIEF DESCRIPTION OF THE DRAWINGS

These and/or other aspects and utilities of the present general inventive concept will become apparent and more readily appreciated from the following description of exemplary embodiments, taken in conjunction with the accompanying drawings, of which:

FIG. 1 is a schematic block diagram of an exemplary general embodiment of the present general inventive concept;

FIG. 2 is a flow diagram of an exemplary rate control process by which the present general inventive concept may be embodied;

FIG. 3 is a schematic block diagram of a video transmission system embodying the present general inventive concept;

FIG. 4 is a schematic block diagram of an exemplary streaming video application embodying the present general inventive concept;

FIGS. 5A-5F are block diagrams illustrating exemplary video data packetization implemented in certain embodiments of the present general inventive concept;

FIG. 6 is a graph depicting an exemplary rate map usable in certain embodiments of the present general inventive concept; and

FIG. 7 is a schematic block diagram of an exemplary rate controller embodying the present general inventive concept.

### DETAILED DESCRIPTION

The present inventive concept is best described through certain embodiments thereof, which are described in detail herein with reference to the accompanying drawings, wherein like reference numerals refer to like features throughout. Enclosure of elements or features by dashed lines is to illustrate exemplary, non-limiting functional divisions for purposes of explanation. Other divisions will be recognized by the skilled artisan upon review of this disclosure. Additionally, it is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

The term data structure is used throughout this disclosure and refers to any collection of data that are processed via machine operations. The ordinarily skilled artisan will recognize numerous data structures that can be used with the present invention such as, for example, video and audio frames, video and audio data streams, digital images, digital data files, and others. Further, in certain embodiments of the present invention, the machine operations by which the data structures are processed may be distributed across a plurality of separate machines through inter-process communications.

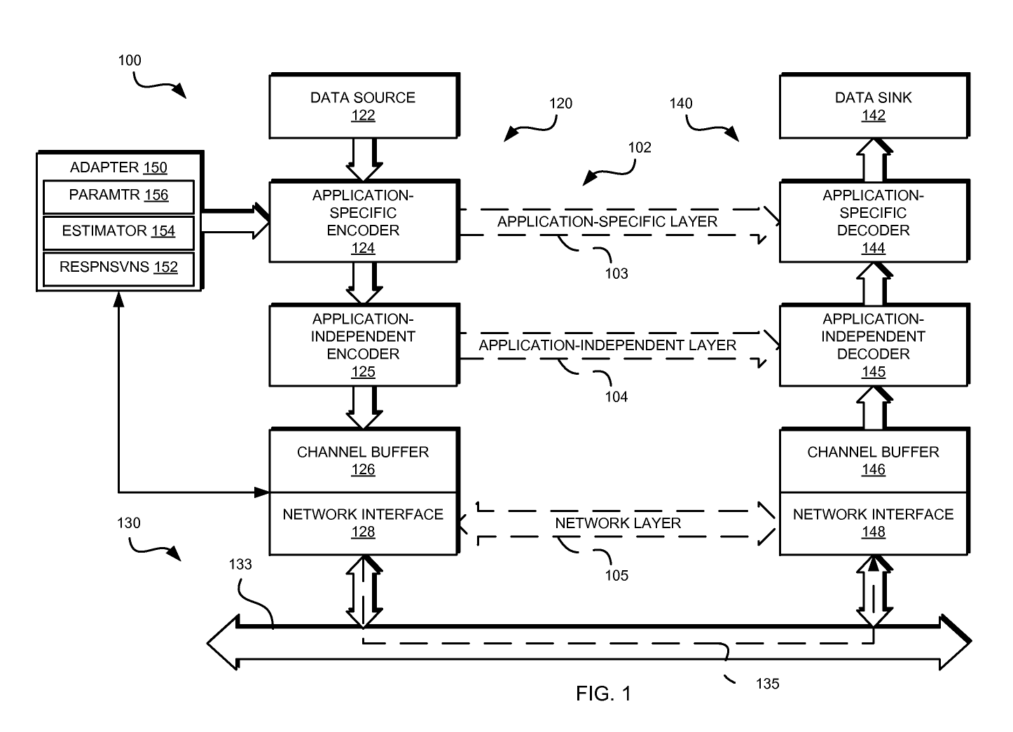

Referring to FIG. 1, there is illustrated an exemplary communication system 100 by which the present invention may be embodied. Communication system 100 includes a source terminal 120 that processes and transmits data to a destination terminal 140. Source terminal 120 and destination terminal 140 may be communicatively coupled through a transmission medium 130, which may support direct transmission, such as via a line-of-sight wireless path or by data signal broadcasting, and/or indirect transmission, such as through various network nodes in a packet switched network. Each of the source terminal 120 and the destination terminal 140 may comprise data processing machine elements and procedures to implement a network protocol stack 102. The exemplary network protocol stack 102 includes an application-specific connection layer 103, on which application-specific communication protocols operate, an application-independent connection layer 104, on which application-independent communication protocols operate, and a network connection layer 105, on which network communication protocols operate.

Exemplary application-specific connection layer 103 provides services of an associated application-specific communication protocol by which inter-process data are communicated. Such application-specific communication protocol services may include, among others, inter-process communication partner discovery, partner resource discovery, inter-process synchronization and conversion between machine-dependent data and machine-independent data formats. Exemplary application-independent connection layer 104 provides the services by which location-to-location communications proceed in accordance with one or more associated application-independent communication protocols. The application-independent communication protocol services may include, for example, packetization, host-to-host session control, flow control, path determination and logical addressing, among others. Exemplary network layer 105 provides services of one or more network communication protocols by which physical conveyance of data through transmission medium 130 is achieved. Such services may include, for example, physical addressing, physically interfacing to transmission medium 130, contention resolution and scheduling, modulation and demodulation of signals transmitted and received over a communication channel 135.

It is to be understood that the exemplary protocol stack 102 illustrated in and described with reference to FIG. 1 is intended to represent generic operating principles of common network stacks for purposes of explaining the present invention. The ordinarily skilled artisan will readily recognize correlating functionality between the exemplary network protocol stack 102 and those of other interconnection models, such as the Internet Protocol (IP) suite and the Open Systems Interface (OSI) suite. The present invention is not limited to a particular protocol stack nor does the present invention require such, per se. Upon review of this disclosure, the ordinarily skilled artisan will recognize and appreciate a wide range of contexts in which the present invention may be used without departing from the spirit and intended scope thereof.

Services of the application-specific connection layer 103 may include encoding of inter-process data, such as by application-specific encoder 124, and decoding thereof, such as by application-specific decoder 144. Similarly, services of application-independent layer 104 may include further encoding of data, such as by application-independent encoder 125, and decoding thereof, such as by application-independent decoder 145. The exemplary application-specific encoder 124 operates to produce a representation of the data structures provided thereto and the exemplary application-independent encoder 125 packetizes the data structure representations and appends various headers and footers to each packet. The size of the data structure representations, referred to herein as a payload when appended with application-independent data for transmission, is variable and the application-specific encoding operations act to decrease the bandwidth requirements of application-specific communications in communication channel 135. On the other hand, the encoding operations of application-independent encoder 125 act to increase the bandwidth requirements of data transmission in channel 135, in that the application-independent encoder 125 appends at least one header for each protocol in accordance with which the packet is encoded. Network interface 128, too, may increase the bandwidth requirements by adding its own headers and/or footers as required for physical conveyance of the application-independent encoded data. The amount of data appended to the payload by the application-independent encoder 125, the network interface 128 and even the application-specific encoder 124, when such data are not derived as information from the data structures themselves, is typically fixed and known, and will be referred to herein as network overhead.

As is illustrated in FIG. 1, source terminal 120 includes an adapter 150 to control processes of the application-specific encoder 124. Exemplary adapter 150 estimates the available network capacity from network behavior monitored and/or probed on the network connection layer 105 and sets the encoding parameters of application-specific encoder 124 in accordance with the estimate. The encoding parameters establish, for example the input and output rates at which the data structures are encoded. To comply with strict delivery deadlines at the application-specific decoder 144, such as time-to-decode restrictions, the rate at which application-specific encoder 124 provides data at its output corresponds to the rate at which the remaining processing operations of the network stack 102 are performed to form network packets at network interface 128 in a manner by which transmission scheduling of the application-specific data can meet the delivery constraints.

In certain embodiments of the present invention, adapter 150 independently controls the input and output data rates of application-specific encoder 124. Moreover, in accordance with achievable benefits of the present invention, the input and output data rates may be controlled as a function of the network behavior about communication channel 135. Prudent selection of input and output rates for application-specific encoder 124, given an estimate of the behavior of the network, affords embodiments of the present invention the means by which network-encoded payloads are assembled, with optimal payload utilization, to meet the delivery and processing deadlines of application-specific decoder 144.

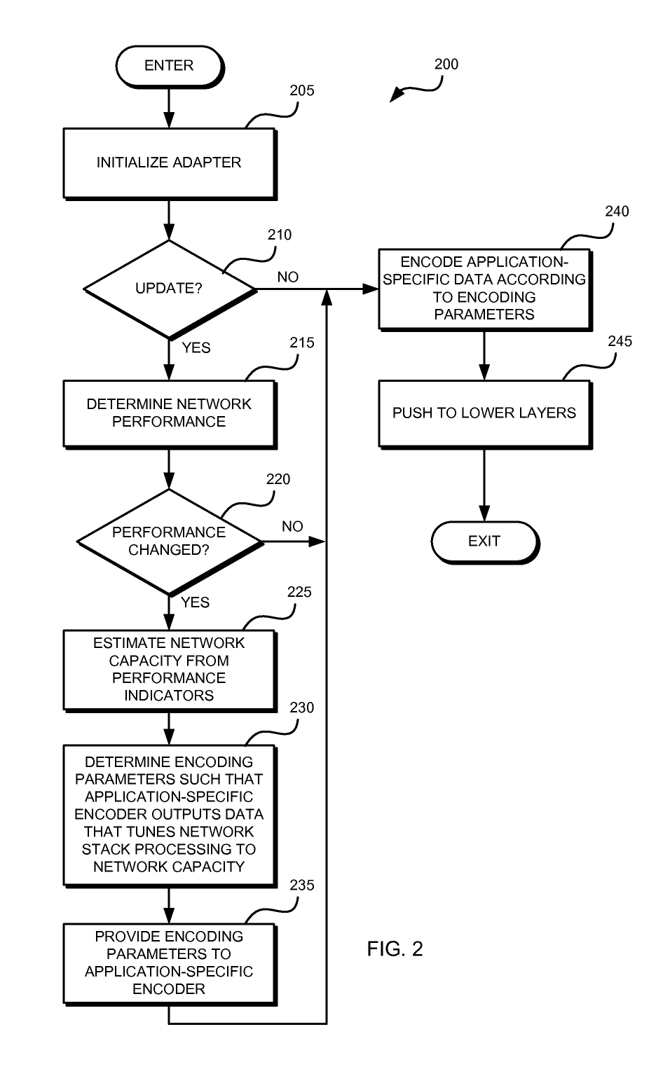

Exemplary adapter 150 includes a responsiveness control unit 152, by which the responsiveness of adapter 150 to changes in network behavior may be controlled, an estimator 154, by which the available capacity of network 133 is estimated, and a parameter setting unit 156, by which operations of application-specific encoder 124 are controlled. An exemplary process 200 utilizing the exemplary adapter 150 is illustrated in and described with reference to FIG. 2.

It is to be understood that the system components illustrated in FIG. 1 are respectively assigned functionality solely for purposes of describing various aspects of the present invention. Such functionality need not be compartmentalized as illustrated in FIG. 1; numerous system configurations may implement the present invention suitably to a particular purpose without deviating from the spirit and intended scope thereof.

Referring now to FIG. 2, there is illustrated an exemplary adaptive encoding process 200 by which the present invention can be embodied. In operation 205, adapter 150 is initialized to a desired responsiveness state and to a desired update interval. The responsiveness state may be controlled by filtering or windowing values corresponding to changes in network behavior and/or by establishing one or more thresholds on system variables, the values of which relative to the established thresholds prescribe the execution of one or more predetermined control actions. The update interval is a user selected system variable during which the encoding parameters remain constant at least until the current interval has lapsed. The update interval may be set to a value corresponding to anticipated variability in network conditions.

An encoding parameter map may also be initialized in operation 205, such as by population of a lookup table. The encoding parameter map may include values of encoding parameters that are associated with a rate estimate. A lookup function, such as may be implemented by parameter unit 156, may retrieve the values of encoding parameters associated with a network rate provided thereto and may then provide the retrieved encoding parameters to the application-specific encoder 124. The values of the encoding parameters may be associated with one or more other values thereof to form sets of encoding parameters that are in turn associated to a single data rate in the parameter map. It is to be understood that the parameter map may be persistently stored in memory and need not be populated at repeated system operation cycles.

In operation 210, it is determined whether the current update interval has lapsed. If not, process 200 transitions to operation 240, by which the application-specific data are encoded according to the currently set encoding parameters and the encoded data are pushed to lower layers of network stack 102, as illustrated at operation 245. If a new update interval is beginning, as determined at operation 210, process 200 transitions to operation 215, whereby the current network behavior is evaluated. Such network behavior may be determined from network performance indicators such as, for example, the traversal time of known network packets from source terminal 120 to destination terminal 140 and the rate at which packets are transferred out of channel buffer 126. Process 200 may then transition to operation 220, whereby it is determined whether the network behavior changed with respect to the established responsiveness limits. If the network behavior is within the established limits, process 200 transitions to operation 240, whereby encoding for the duration of the new update interval remains at the rates established in the previous interval. If the variability in the network behavior is outside of the sensitivity limits, as determined in operation 220, process 200 transitions to operation 225, whereby available capacity of the network 133 is estimated from the networks performance indicators, such as by estimator 154.

Having estimated the network capacity, process 200 may transition to operation 230, whereby the encoding parameters associated with the estimated network capacity are determined by the parameter unit 156. Encoding parameters are selected that produces a data rate at the output of application-specific encoder 124 that is tuned to the remaining processes of network stack 102 in light of the available network capacity. As the skilled artisan will recognize, data are encoded and buffered at various processing stages of network stack 102. The latency in processing and, accordingly, the amount of data that are buffered at each processing stage, is dependent upon the rate at which data are output by application-specific encoder 124, the rate at which other network stack processes are performed, and the rate at which network encoded data are transmitted from the source terminal 120. Tuning, as used herein, refers to timing the formation of network encoded packets by the network stack 102 in a manner that increases the probability that, when transmitted in accordance with a corresponding packet transmission scheduling scheme, the payload utilization of the packets conforms to the delivery requirements of application-specific decoder 144 in view of the available network capacity. Such payload utilization should further minimize the impact of lost packets at data sink 142.

The encoding parameters determined by process 230 may be provided to application-specific encoder 124 by the parameter unit 156. The encoding parameters may be determined a priori and stored in a lookup table or may be determined through a suitably programmed computation routine. Process 200 may then transition to operation 235 whereby the retrieved encoding parameters are provided to application-specific encoder 124. Process 200 may then transition to operation 240, whereby the data structures are encoded in accordance with application-specific encoding parameters.

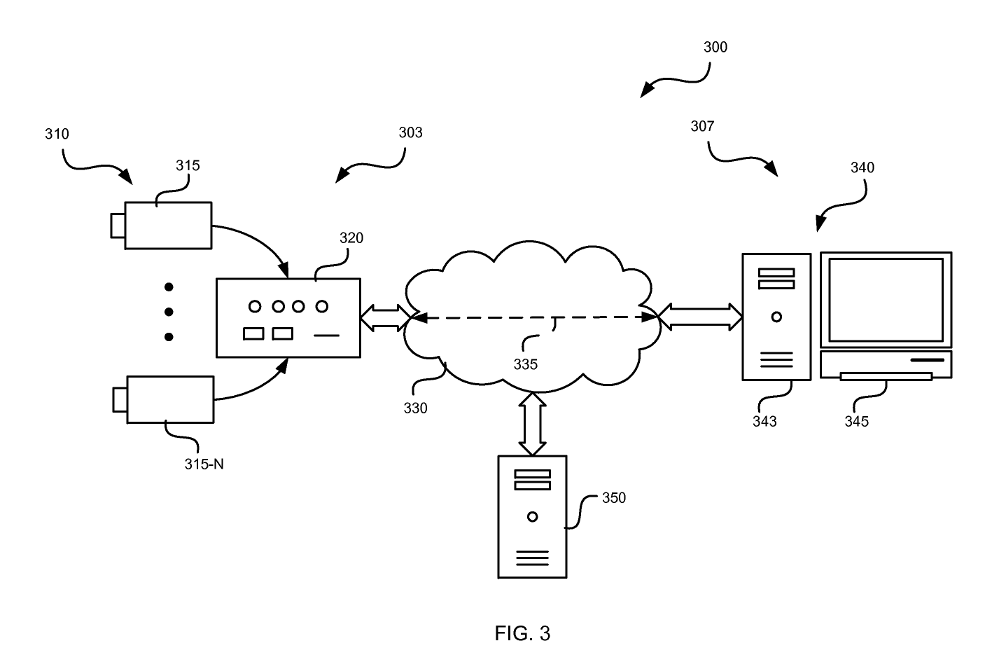

It should be appreciated that a need for the present invention arises in real-time video transmission, as will now be described with reference to FIGS. 3-7. Whereas, the functional divisions of FIG. 1 are not explicitly illustrated and described in the following description, the principles described relative to FIG. 1 will be carried through to the remainder of this disclosure. The ordinarily skilled artisan can readily correlate the functionality between embodiments and, in so doing, appreciate other applications that would enjoy the benefits of the present invention.

An exemplary video transmission system 300 embodying the present invention is illustrated in FIG. 3. As illustrated in the figure, exemplary video system 300 includes a source terminal 303, at which video data are generated, encoded and transmitted to a destination terminal 307. Source terminal 303 and destination terminal 307 are communicatively coupled via one or more communication channels, representatively illustrated at 335, formed in a communication network 330. Network 330 may be a direct connection between source terminal 303 and destination terminal 307 or may comprise various switching mechanisms through which a physical link is ultimately provided. For example, network 330 may be a packet switched network, such as a cellular telecommunication network or wired or wireless Internet Protocol (IP) network.

Exemplary source terminal 303 includes a data source, exemplified by multichannel camera system 310 comprising one or more cameras 315 through 315-N. Except where not otherwise apparent, all cameras of camera system 310 will be representatively referred to herein simply as camera 315. Each camera 315 of camera system 310 is coupled to an input channel of Streaming Video Appliance (SVA) 320, by which video data are captured, encoded and conveyed over network 330 in accordance with the present invention. The video data captured from camera system 310 may be encoded into one or more video data streams, such as a Motion Picture Expert Group (MPEG) elementary streams (ES) that may be incorporated into one or more transport streams, such as, for example, MPEG transport streams (TS). A selected number of TS packets may be encapsulated in a transport layer protocol packet, such as a packet complying with the User Datagram Protocol (UDP) and/or the Real-time Protocol (RTP). The encapsulated transport packet may be further encapsulated for in accordance with other network protocols for conveyance to destination terminal 307 over communication channel 335, referred to herein as video data channel 335.

Exemplary destination terminal 307 includes a data sink by which video data received thereat are processed, displayed, and optionally stored. In the exemplary embodiment illustrated in FIG. 3, the destination terminal 307 includes a server 343, by which the data transmitted from source terminal 303 are received and stored, and a workstation 345, by which the video data are processed and displayed to a user. The combination of server 343 and workstation 345 will be referred to herein as Data Collection and Monitoring Station (DCMS) 340 and implements all the functionality necessary to receive, decode and display video data received from source terminal 303. The present invention is not limited to a particular distribution of the functionality of DCMS 340 between the server 343 and workstation 345.

In certain embodiments of the present invention, data other than video data are transferred between source terminal 303 and destination 307. For example, SVA 320 may transmit and receive test data by which the performance of network 330 may be evaluated. Additionally, source terminal 303 may be in communication with other systems, representatively illustrated as server system 350. In certain embodiments of the present invention, at least one server system 350 is persistently reachable on network 330, such as through a static IP address. SVA 320 may determine the performance of network 330 from network performance indicators corresponding to traffic between source terminal 303 and server 350. When so embodied, server system 350 should be physically located in close proximity to the DCMS 340 so that the network performance indicators obtained through traffic between SVA 320 and server 350 is representative of network behavior between SVA 320 and DCMS 340.

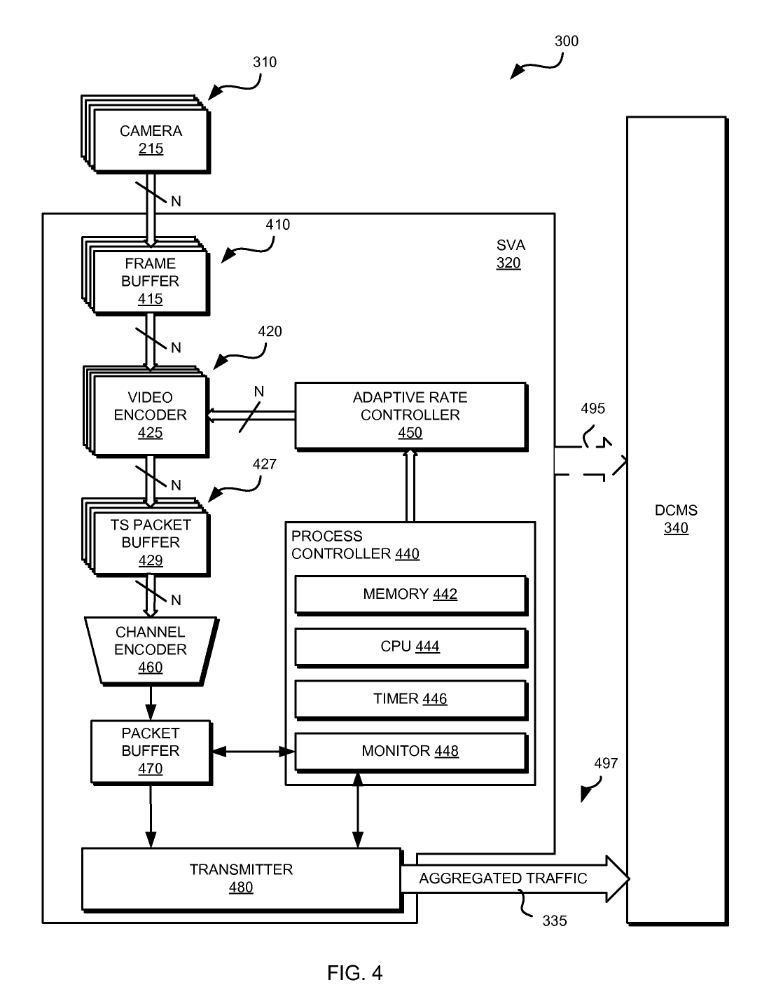

FIG. 4 illustrates an exemplary system configuration of SVA 320, by which a video data are conveyed to DCMS 340 in accordance with an application layer protocol 495. SVA 320 may be implemented in suitable hardware or in a combination of hardware and software and may include system components other than those illustrated and described with reference to FIG. 4, such as, for example, persistent memory in which video data are stored even when power is removed therefrom.

It should be observed and appreciated that services of application layer 495 of exemplary video transmission system 300 include multi-channel video encoding of video frames generated by a multi-channel data source 310, while the services of the network layer 497 include aggregating the encoded video data and then encoding the aggregated video data in accordance network protocols, such as by channel encoder 460, into a plurality of packetized payloads. The packetized payloads, i.e., the network packets, may be stored in a channel buffer 126 to await transmission over data channel 135. Packet buffer 470 must be sized appropriately to accommodate a reasonable number of network packets in view of the expected network behavior, the requirements for which increase as the number of cameras 315 in camera set 310 increases. Packet buffer 470 may include a mechanism by which its occupancy can be ascertained, such as by a counter or occupancy flags.

Exemplary SVA 320 includes a process controller 440 by which, among other things, functions of SVA 320 are monitored and controlled. Process controller 440 may include a central processing unit 444 to execute machine operations by which the functionality thereof is achieved. Process controller 440 may further include a memory unit 442 to store, among other things, machine instructions, data, and system and process variables.

Exemplary process controller 440 includes an update timer 446 to periodically initiate a network assessment and system update process. For example, update timer 446 may generate a periodic electrical signal of period Tₖ, referred to herein as an update interval, that compels monitor 448 to determine the performance state of network 330. The performance state of network 330 may be provided to adaptive rate controller 450 and, when appropriate, video data encoding parameters are updated in accordance therewith.

In certain embodiments of the present invention, each video encoder 425 in video encoder set 420 is a piecewise constant bit-rate video encoder. That is, the encoder output bit-rate is constant over a certain time interval, such as over the update interval Tₖ, and is modified only upon an instruction to do so, such as from adaptive rate controller 450. Thus, for the update interval Tₖ, the available capacity of the video data channel 335, as estimated from the state of communication network 330, can be maximally consumed by efficiently packed network packets. Additionally, in certain embodiments of the present invention, certain modifications to encoding operations of each video encoder 425 may be made upon receipt of the corresponding encoding parameters without terminating encoding operations that are in progress. For example, changes in video frame resolution, quantization level and number of video frames represented in an MPEG Group of Pictures (GOP) and the makeup of the GOP video with regard to the number of motion compensated video frames, may be made to encoders 325 without having to clear the TS encoding stack.

As is illustrated in FIG. 4, a frame buffer set 410 may be communicatively coupled to camera system 310 to include a frame buffer 415 for each camera 315. Each frame buffer 415 comprises suitable video data storage to store a plurality of sequential video frames provided by a corresponding camera 315. The video encoder set 420 may encode the video data at a selected input frame-rate, when such is established as an encoding parameter, where data frames are selected from the corresponding frame buffer 415 in accordance with the input frame-rate. Additionally, each video encoder 425 may packetize the constant rate bit-stream a plurality of application-specific packets, such as MPEG2 TS packets, which may be stored in respective TS packet buffers 429 of TS packet buffer set 427. Exemplary channel encoder 460 is communicatively coupled to TS packet buffer set 427 to receive the packetized constant bit-rate video data streams, whereby the encoded video data packets are aggregated and formatted for transmission to DCMS 340 in accordance with the connection layer protocols governing such.

Transmitter 480 transmits the network packets in accordance with communication protocols suitable to the physical transmission medium for which the present invention is implemented. Transmitter 480 may modulate and amplify a signal, such as an electric or electromagnetic signal, appropriately for the transmission medium. Exemplary transmitter 480 is the interface between SVA 320 and communication network 330 and may transmit packets only when signals allowing such are received at the transmitter 480, such as by a transmission scheduler (not illustrated). Thus, the number of network packets in packet buffer 470 increases and decreases with the rate at which transmitter 480 is allowed to transmit channel packets. The number of network packets stored in packet buffer 470 awaiting transmission will be referred to herein as queue backlog.

The operational state of network 330, e.g., the state of data flow congestion in the network 330, may be determined, such as by monitor 448. In certain embodiments of the present invention, the operational state is determined from locally obtained network performance indicators, the acquisition of which have little to no impact on the flow of data in network 330, i.e., from network performance indicators that do not rely on responses or data receipt acknowledgments from DCMS 340. For example, monitor 448 may compel an Internet Control Message Protocol (ICMP) echo packet to be transmitted to DCMS 340, or to a location proximal thereto, by which a representative packet round trip time (RTT) may be determined therefrom. The packet RTT is indicative of the state of host-to-host connectivity of video data channel 335. Additionally, monitor 448 may determine the packet backlog from the occupancy of the packet buffer 470. The packet backlog is indicative of the extent to which network 330 is being shared with other data transmission sources. The network performance indicators relating to the operational state of network 330 may be provided to adaptive rate controller 450, whereby the video encoder set 420 is configured to optimize the encoding of the video data in accordance with an estimated available network capacity determined therefrom.

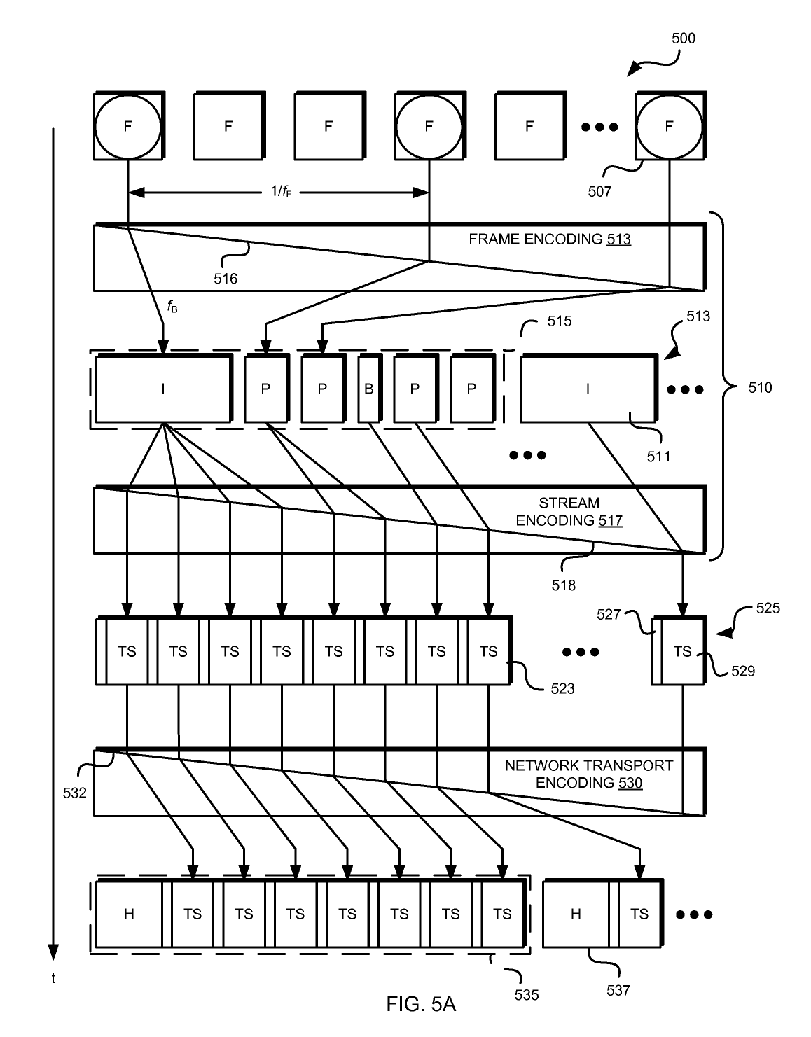

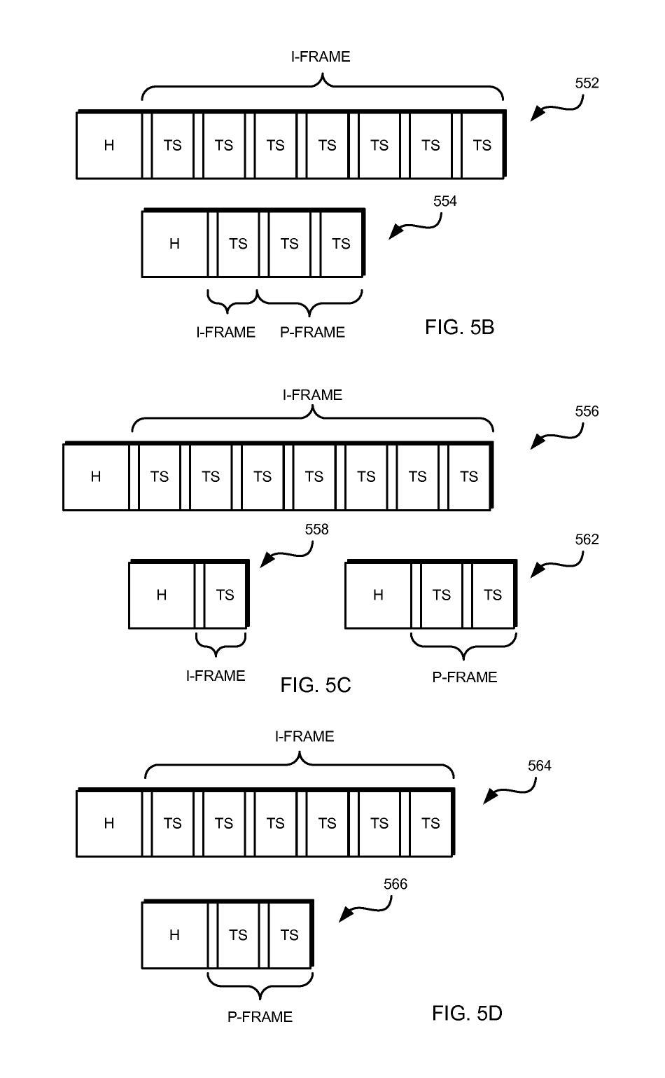

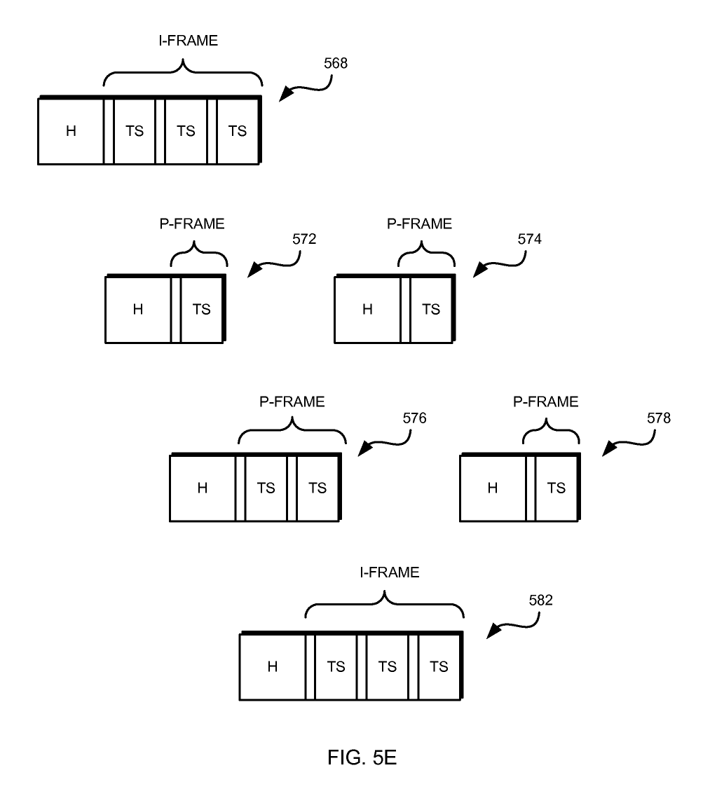

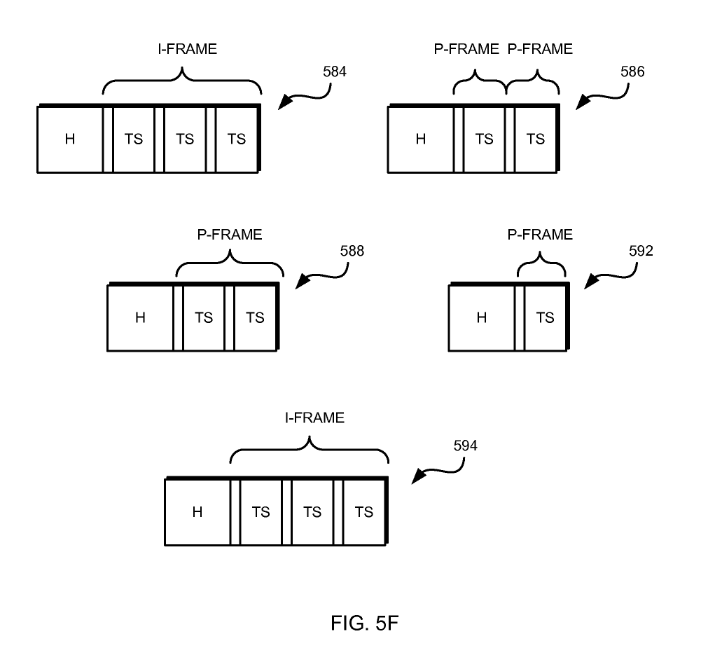

FIGS. 5A-5F, referred to herein collectively as FIG. 5, depicts an exemplary video encoding stack 500 embodying certain principles of the present invention. It is to be understood that only those elements necessary for describing such principles of the present certain are illustrated in FIG. 5 and that certain elements required for a complete implementation of encoding stack 500 have been omitted to avoid congestion in the drawing. The exemplary encoding stack 500 illustrated in FIG. 5 is presented for purposes of description and not limitation and the ordinarily skilled artisan may recognize system configurations other than that of encoding stack 500 that can embody the present invention without deviating from the spirit and intended scope thereof.

As is illustrated in FIG. 5A, encoding stack 500 comprises an transport stream (TS) stack 510, the output of which is provided to network transport encoding process 530. Exemplary TS stack 510 may be implemented as a component of each video encoder 325 of video encoder set 320 and includes a frame encoding process 513, the output of which is provided to a stream encoding process 517. A buffer, representative illustrated by the diagonal lines 516, 518, 532, may be implemented at each process 513, 517, 530 in which data structures awaiting processing can be temporarily stored. In the exemplary encoding stack 500, each buffer 516, 518, 532 is a first-in/first-out (FIFO) buffer, although it is to be understood that the present invention is not so limited.

Video frames, representatively illustrated by video frame 507, are retrieved from buffer 516 and encoded by frame encoding process 513 to produce GOPs, representatively illustrated by an MPEG GOP 515, each comprising intra-coded frames, commonly referred to as I-frames, predictively-encoded frames, commonly referred to as a P-frames, and, in some implementations, bi-directional predictively-encoded frames, commonly referred to as B-frames. The encoded frames, representatively illustrated by encoded frame 511, are stored in buffer 518 and retrieved therefrom by stream encoding process 517 to produce TS 525. TS 525 comprises TS packets, representatively illustrated by TS packet 523, each containing a header 527 and a payload 529. TS packets are stored in buffer 532 and packetized into UDP packets 535 for transmission. The header 537 of UDP packets 535, and other headers and trailers by which the UDP packets 537 are conveyed over data channel 135 is considered network overhead.

As is illustrated in FIG. 5A, each TS packet 523 may contain data that is less than that of a complete I-, P-, or B-frame. Encoded video frames 511 are first encoded into a bit stream, such as an MPEG2 elementary stream (ES), and then ultimately packetized into MPEG2-TS packets 523, typically 188 bytes in size. I-frames being the largest of encoded frames 511 are likely to span several MPEG2 TS packets 523. P-frames are smaller than I-frames (and B-frames are typically smaller still) and are thus likely to fit in one or two MPEG2-TS packets 523. The number of TS packets 523 required to carry individual encoded frames 511 is dependent upon the coarseness of the data representing the corresponding video frame 507 as dictated by, for example, the image resolution and data quantization level.

For purposes of illustration, it is to be assumed that UDP packet 535 encapsulates up to seven (7) MPEG2-TS packets without violating a 1500-byte MTU size. It is to be assumed further that segments of a particular frame have to be received at the decoder to meet decoding and presentation deadlines. In certain circumstances, then, the system packet scheduler may be compelled to send a UDP packet if data for such is available for transmission, regardless of whether the UDP packet is fully utilized. For example, an I-frame followed by a P-frame sequence, where the size of the I-frame is such that it spans eight (8) MPEG2 TS packets and the size of the P-frame is such that it spans only two (2) MPEG2 TS packets, if the TS data are available in buffer 532, the frames would be packetized by network encoding process 530 in a manner illustrated in FIG. 5B, where UDP packet 552 includes a header and seven (7) MPEG2 TS packets and UDP packet 554 includes a header, one (1) MPEG2 TS packet for the I-frame and two (2) MPEG2 TS packets for the P-frame. However, under strict delivery constraints, transmission delay of packet 554, such as to allow enough time for the P-frame to be encoded, may induce errors at the decoder if all of the I-frame data are not delivered to the decoder before the P-frame data are delivered. Alternatively, network transport encoding process 530 may packetize the frames as illustrated in FIG. 5C, i.e., UDP packet 556 would include a header and seven (7) MPEG2 TS packets for the I-frame, UDP packet 558 would include a header and one (1) MPEG2 TS packet for the I-frame, and UDP packet 562 would include a header and two (2) MPEG2 TS packets for the P-frame. The difference between the scenario depicted in FIG. 5B and that of FIG. 5C is the additional overhead of one (1) UDP header.

In accordance with certain principles of the present invention, the rate at which video frames are introduced to frame encoding process 513, representatively illustrated as input frame-rate f_{F}, is selected by adaptive rate controller 350 to correspond with the performance state of network 230. Prudent selection of the frame-rate f_{F} may be used to establish the UDP packet transmission timing in that it establishes the temporal interval between I-frames and P-frames and, accordingly, the availability of TS packets corresponding to the encoded frames at the network transport encoding process 530. The video bit-rate of frame encoding process 513, representatively illustrated as f_{B}, establishes the size of encoded frames 511; a higher bit-rate f_{B} results in an encoded frame 511 with higher informational content. A higher bit-rate f_{B} translates potentially to a greater number of TS packets 523 required to transport the frame. Thus, in accordance with the present invention, the frame-rate f_{F} and bit-rate f_{B} may be associated in pairs to define the makeup and transmission timing of UDP packets 535.

Assuming the same frame-rate as that described with reference to FIG. 5C and reducing the video bit-rate, the I-frame can be encoded to span only six (6) MPEG2 TS packets. Thus, UDP packets can be constructed as illustrated in FIG. 5D, where UDP packet 564 includes a header and six (6) MPEG2 TS packets for the I-frame and UDP packet 566 includes a header and two (2) MPEG2 TS packets for the P-frame. In this example, the same number of frames is transmitted with reduced overhead, making the reduced video bit-rate a better pairing with the given frame-rate

In general, a high frame-rate coupled with low bit-rate would result in high overhead, since encoded MPEG2-TS packets not only have very little time to be buffered, but are typically very small. If it is assumed that video frames 511 are encoded such that I-frames span three (3) MPEG2 TS packets and P-frames primarily span one (1) MPEG2 TS packets, a sequence of I P P P P I would likely to be packetized as illustrated in FIG. 5E, where UDP packet 568 includes a header and three (3) MPEG2 TS packets for the first I-frame, UDP packets 572 and 574 each include a header and one (1) MPEG2 TS packet for corresponding P-frames, UDP packet 576 includes a header and two (2) MPEG2 TS packets for a larger P-frame, UDP Packet 578 includes a header and one (1) MPEG2 TS packets for the final P-frame and UDP packet 582 header and three (3) MPEG2 TS packets for the second I-frame. If the frame-rate is reduced, giving more time for P-packets to collect in buffer 518 of stream encoding process 517, packetization may occur as illustrated in FIG. 5F, where UDP packet 584 includes a header and three (3) MPEG2 TS packets for the I-frame, UDP packet 586 includes a header and two (2) MPEG2 TS packets for respective P-frames, UDP Packet 588 includes a header and two (2) MPEG2 TS packets for the larger P-frame, UDP Packet 592 includes a header and one (1) MPEG2 TS packet for the final P-frame and UDP Packet 594 includes a header and three (3) MPEG2 TS packets for the second I-frame. The skilled artisan will readily recognize and appreciated the network overhead has been reduced by one UDP header in the packetization illustrated in FIG. 5F over that of FIG. 5E.

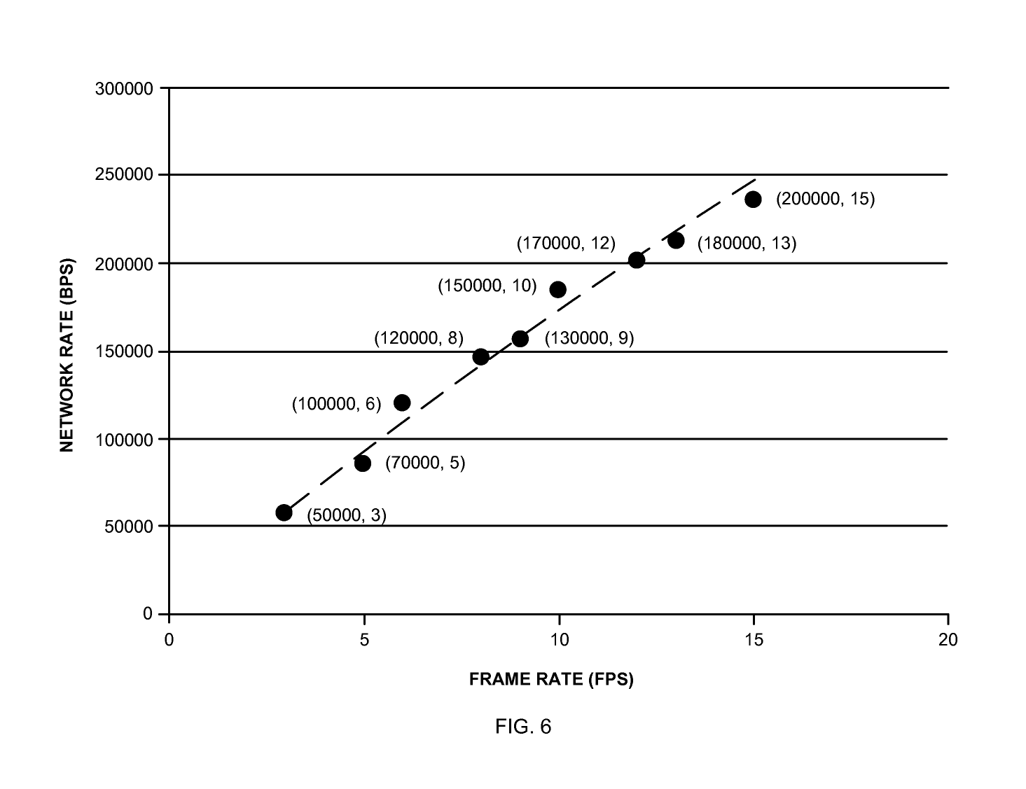

FIG. 6 depicts an exemplary rate map 430 in graphical form for a particular encoder implementation. The discrete data points represent calculated video bit-rate/frame-rate pairs for the encoder implementation and the solid line represents a curve fit to the discrete data points. The rate mapper 440 retrieves a video bit-rate/frame-rate pair from the rate map 430 for an allocated network bit by which the minimum network overhead percentage is achieved.

An optimum pairing of bit-rate/frame-rate pairs may be determined by careful examination of the operation of the encoding scheme (number of I and P frames, their sizes for a given resolution, etc), and knowledge of processing and buffering delays of the encoder. Alternatively, such pairing may be determined through empirical study, such as by encoding data from a known test video source and capturing the packets put on the network. Optimal encoding parameter may be selected as those yielding the lowest network overhead for a given ratio of network bit-rate to the video bit-rate. In certain embodiments of the invention, optimal encoding parameters are those that achieve encoding by which network overhead is 16%-18% of the total data transmitted in data channel 335.

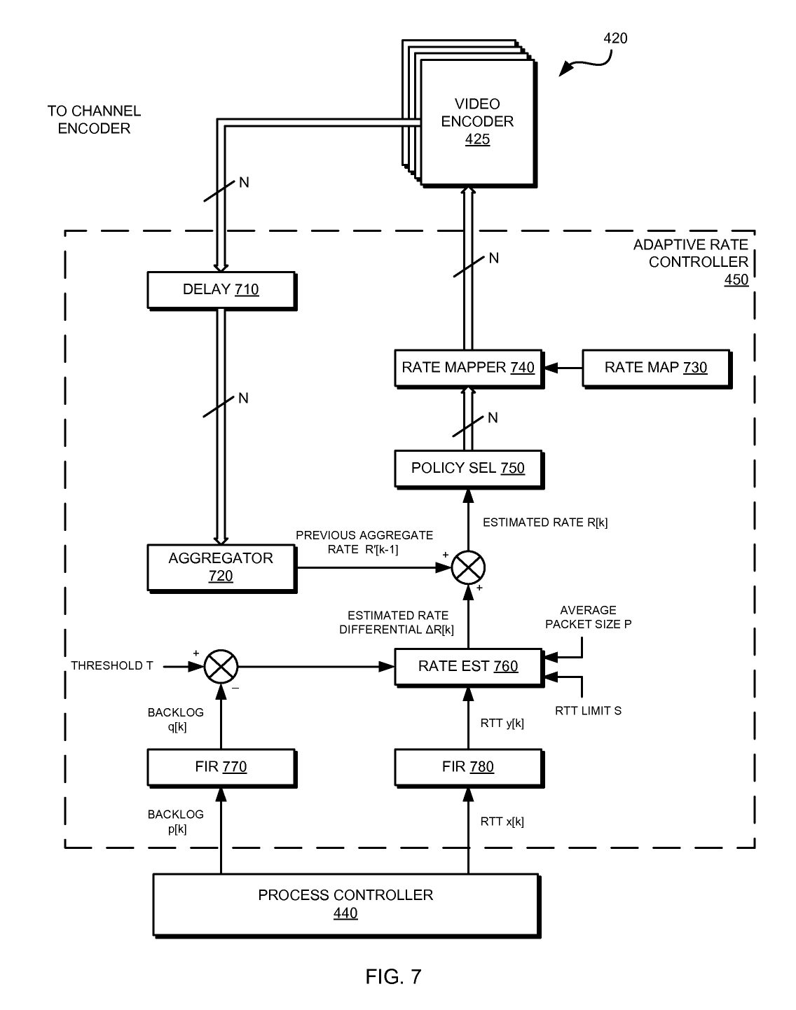

In FIG. 7, there is illustrated an exemplary adaptive rate controller 450. Adaptive rate controller 450 is communicatively coupled with video encoder set 420 by which the distributed encoding rate thereof may be established over an update interval Tₖ. Adaptive rate controller 450 is additionally coupled to process controller 440 to receive therefrom sampled network performance indicators such as, for example, the instantaneous channel backlog p[k] and the instantaneous RTT x[k] of a query packet, where the index variable k is incremented at the onset of each update interval Tₖ established by, for example, update timer 446.

In certain embodiments of the invention, the responsiveness to changes in the encoding parameters is controlled to limit the effect of variations in instantaneous network performance indicators p[k] and x[k]. The channel backlog sample p[k] may be applied to a finite impulse response (FIR) filter 770, referred to herein as backlog filter 770, through a machine implementation of a filtering function, such as,

q[k]=Σᵢ₌₀^{L}cᵢp[k−i], (1)

where q[k] is the filtered backlog signal, referred to herein simply as the backlog signal q[k] and cᵢ=0, . . . , L are the filtering weights of the FIR filter of order L. Similarly, the filtered RTT signal y[k], referred to herein simply as the RTT signal y[k] is obtained through a machine implementation of a filtering function in RTT filter 780, such as,

y[k]=Σᵢ₌₀^{M}bᵢx[k−i], (2)

where bᵢ=0, . . . , M are the filtering weights of the FIR filter of order M. The filtering weights cᵢ and bᵢ may be prudently selected to regulate the responsiveness of the adaptive rate filter. For example, a more responsive system may be attained with greater weight being applied to more recently acquired samples, e.g., c₀>c₁> . . . >c_{L} and b₀>b₁> . . . >b_{M}. For a less responsive system, greater weight may be applied to earlier acquired samples. In certain embodiments of the present invention, the coefficients cᵢ and bᵢ have a distribution whereby greater weight is applied to samples in the center of the filter temporal span. For example, the coefficients cᵢ and bᵢ may distributed according to a curve such as,

cᵢ=e^{-(i-L/2)} and, bᵢ=e^{-(i-M/2)}. (3)

Upon review of this disclosure, the ordinarily skilled artisan will recognize numerous alternative filter configurations by which responsiveness of the adaptive rate controller 450 to changes in network performance indicators can be controlled. All such alternatives may be used in conjunction with the present invention without deviating from the spirit and intended scope thereof. Responsiveness may further be controlled by a threshold on one or more system variables through which the encoder is adapted, such as on the backlog signal q[k] and/or the RTT signal y[k].

Exemplary rate estimator 760 generates through suitable machine operations an estimated rate differential ΔR in bits/second according to the relation:

$$Δ R [ k ] = \{ \begin{matrix}P \cdot ( T - q [ k ] ) \cdot 8 / y [ k ] , & T \geq q [ k ] \\ P \cdot ( T - q [ k ] ) \cdot 8 / ( S - y [ k ] ) , & T < q [ k ]\end{matrix} \qquad ( 4 )$$

where P is the average size, in bytes, of the packets that are buffered in packet buffer 470 and S is an upper limit on the maximum RTT y[k]. Average packet size P is normally a function of the network bit-rate of the video encoders and the underlying network stack, but could be set to a fixed value, for example to the MTU of the network. T is a tunable threshold, in number of packets, with which backlog q[k] is compared to determine whether SVA 320 should execute predetermined action, such as to reduce the output bit-rate of the video encoders 420 to preemptively prevent packet buffer 470 from overflowing. The value of threshold T with respect to the size of the buffer controls the reactiveness of encoder set 420 to the changes in available network rate and to the increasing possibility of packet drops due to buffer overflows. Combined with the backlog filter 770 and the RTT filter 780, which control the window of past history of queue backlogs and RTT indicators, respectively, from which the rate estimation is derived, the system can be easily tuned for different communication channels 335.

The available network rate for the period Tₖ may be determined from the relation:

R[k]=max(0, R′[k−1]+ΔR[k]), (5)

where R′[k−1] is the actual aggregate data rate from the previous interval Tₖ₋₁, which, as illustrated in FIG. 4, may be obtained from a suitable delay line 710 and aggregator 720. Aggregator 720 sums the output bit-rate distributed across all video encoders 425 in encoder set 420. In general, R[k−1] ≠R′[k−1], because the video encoders 425 operate over a discrete set of encoding parameters, e.g., input frame-rate and bit-rate, that cannot be set to any arbitrary value.

The newly estimated rate R[k] may be provided to a policy selector 750, by which the available network rate R[k] can be distributed among the outputs of all video encoders 425 of video encoder set 420. The output of policy selector 750 is a set of bit-rates {r₁[k], . . . , r_{N}[k]}, referred to herein as a rate distribution vector, such that:

R[k]=Σ₁^{N}rᵢ[k], (6)

where the elements rᵢ[k] are assigned to respective video encoders 425 in video encoder set 420. The distribution of rates rᵢ[k] across the rate distribution vector may be assigned in accordance with the requirements of a particular setting in which the present invention is deployed. For example, if one camera, say camera 315-1, is monitoring a region that is relatively static in comparison to the region monitored by another camera, say camera 315-2, more of the available bit-rate R[k] may be allocated to the video encoder 325-2 coupled to camera 315-2 than is allocated to video encoder 425-1 coupled to camera 315-1, i.e., r₂[k]>r₁[k]. The ordinarily skilled artisan will recognize and appreciate the flexibility by which the available network rate R[k] can be allocated across multiple data processing channels.

As is illustrated in FIG. 7, the rate distribution vector may be provided to rate mapper 740, by which the allocated bit-rate rᵢ[k] is mapped to a video bit-rate and frame-rate pair (bᵢ, fᵢ)[k] to achieve the minimum network overhead percentage. As discussed above, there exists a video-bit-rate and frame-rate pair at which a given encoder implementation operates with minimum network overhead. This operating point is associated with a corresponding value of the allocated network bit-rate assigned to the video encoder 425 to transmit maximum useful video data per network bit-rate used. The encoding parameter pair (bᵢ, fᵢ)[k] may be stored in a rate map 430. In certain embodiments of the present invention, the encoding parameters are fit to a curve that is a non-linear function of the parameters involved and implemented through suitable machine operations that returns encoding parameter pair (bᵢ, fᵢ)[k] for an input available network rate.

A numerical demonstration of the benefits of the present invention is provided below in Table 1, whereby typical video transmission systems, both with and without the present invention being embodied therein, are compared. In both scenarios, the system uses identical video encoders and the same wireless communication channel. In the first case, the system operates without the beneficial implementation of the present invention, in which the encoder video bit-rate is set to 100 kbps (constant bit-rate) and the frame-rate is set to 10 frames per second. In the second instance, the system embodies the present invention. Both instances are observed during an hour of video transmission and with network interface buffer to 20 packets. In the embodiment of the present invention, the buffer threshold T=10 packets, M=L=8 are the FIR filter orders, and a moving average FIR filter is applied to both queue backlog and RTT samples.

TABLE 1

| | CBR Video | | Inventive Rate Control | |
|---|---|---|---|---|
| Average Video | 100 | kbps | 120 | kbps |
| Bit-rate/Hour | | | | |
| Average Frame- | 10 | fps | 8.12 | fps |
| rate/Hour | | | | |
| Number of Packets | 71352 | packets | 64410 | packets |
| Sent/Hour | | | | |
| Number of Packets | 16292 | packets | 4071 | |
| Dropped/Hour | | | | |
| Percentage | 22% | | 6% | |
| Dropped | | | | |
| Average Queue | 13.56 | packets | 7.28 | packets |
| Backlog | | | | |
| Useful Bytes | 630 | bytes/packet | 838 | bytes/packet |
| per Packet | | | | |

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

What is claimed is:

1. An encoding apparatus to encode a sequence of data structures in a communication device coupled to a communication network at a local location for transmission to a remote location, the apparatus comprising:
a network interface to transmit a plurality of packets to a communication network in accordance with a network communication protocol, the packets containing respective segments of an encoded bitstream, the number of segments in each of the packets being independent of the number of segments in other of the packets;
an adapter to, at predetermined temporal intervals, estimate from locally obtained network performance indicators a capacity in the communication network in which the packets are transmittable to the remote location, the adapter generating encoding parameters associated with the estimated capacity such that the segments of the encoded bitstream as encoded in accordance with encoding parameters are distributed in number across the packets to meet predetermined requirements for delivery thereof at the remote location; and
an encoder to encode the data structures during the temporal interval in accordance with the encoding parameters to generate a constant bit-rate bitstream therefrom as the encoded bitstream such that the segments thereof are in the distribution across the packets at the network interface.

2. The apparatus as recited in claim 1, wherein the adapter includes a parameter unit associating the estimated network capacity to a set of values of the encoding parameters, the adapter providing the set of values of the encoding parameters to the encoder responsive the network capacity estimate.

3. The apparatus as recited in claim 2, wherein the set of encoding parameters provided by the parameter unit includes an input rate at which data structures are accepted as input to the encoder and the constant bit-rate of the encoded bit stream.

4. The apparatus as recited in claim 3, wherein the values of the input rate and the constant bit-rate are associated as a predetermined pair for the associated network capacity estimate.

5. The apparatus as recited in claim 4, wherein the encoder encodes the data structures with the values of the pair of input rate and constant bit-rate to achieve a ratio of network overhead to encoded bitstream data of between 16%-18%.

6. The apparatus as recited in claim 1, wherein the adapter includes a sensitivity control device to control a change in a value of the encoding parameters with respect to a change in the network performance indicators.

7. An encoding apparatus to encode structured video data generated at a local location for transmission through a communication network to a remote location in compliance with a network communication protocol, the apparatus comprising:
a network interface to transmit a plurality of network packets compliant with the network communication protocol, the network packets containing a respective number of segments of a bitstream encoded from the video data that is independent of the number of segments in other of the packets;
a rate controller to, at predetermined temporal intervals, estimate from at least one locally obtained network performance indicator an available capacity in the communication network within which the network packets are transmittable to the remote location, the rate controller generating at least one encoding parameter by which the segments of the video bitstream as encoded in accordance therewith are distributed in number across the packets to meet predetermined requirements for delivery thereof at the remote location; and
a video encoder set communicatively coupled to the network interface and the rate controller to encode the video data into a constant bit-rate bitstream as the video bitstream in accordance with the encoding parameters provided thereto such that the segments thereof are in the distribution across the packets at the network interface.

8. The apparatus as recited in claim 7, further comprising:
a channel buffer to store the network packets awaiting transmission through the communication network, the channel buffer providing a signal indicative of a number of the network packets stored therein.

9. The apparatus as recited in claim 8, further comprising:
a monitor communicatively coupled to the channel buffer to obtain the network performance indicators during each of the temporal intervals, the monitor receiving the signal from the channel buffer whereby the number of network packets stored therein is provided to the rate controller as one of the network performance indicators.

10. The apparatus as recited in claim 9, wherein the monitor is communicatively coupled to the network interface, the monitor compelling transmission of a test packet through the communication network, whereby a round trip traversal time thereof to and from a location on the communication network is provided to the rate controller as one of the network performance indicators.

11. The apparatus as recited in claim 7 further comprising:
a rate mapper wherein specific values of a plurality of the at least one encoding parameter are set-wise assigned to respective values of the network capacity estimate.

12. The apparatus as recited in claim 11, wherein the plurality of encoding parameters include a video data input rate at which the video data structures are accepted into the video encoder and the constant bit-rate.

13. The apparatus as recited in claim 12, wherein the video encoder encodes the video data structures with the values of the pair of video input rate and constant bit-rate to achieve a ratio of network overhead to encoded video bitstream data of between 16%-18%.

14. The apparatus as recited in claim 7, wherein the rate controller includes a responsiveness control device to control a change in a value of the encoding parameter with respect to a change in the network performance indicators.

15. The apparatus as recited in claim 14, wherein the responsiveness control device includes a filter system to provide temporally representative network performance indicators through an application of predetermined weighting coefficients on the network performance indicators.

16. The apparatus as recited in claim 15, wherein the responsiveness control device evaluates a backlog of the network packets in the channel buffer against at least one predetermined threshold.

17. The apparatus as recited in claim 7, further comprising:
a plurality of video encoders in the video encoder set, each video encoder receiving distinct video data;
a rate estimator to determine an aggregate data bit-rate from the network performance indicators corresponding to the estimated network capacity;
a policy selector to distribute the aggregate data bit-rate as partial data bit-rates over the video encoder set; and
a rate mapper to generate the encoding parameters for each of the video encoders in the video encoder set in accordance with the partial data bit-rates respectively assigned thereto.

18. A machine implemented method for encoding structured data at a local location for transmission over a communication network to a remote location, the method comprising:
assigning values to encoding parameters to correspond to values of an estimated network data capacity such that segments of an encoded bitstream encoded in accordance with the encoding parameters are distributed in number across respective network packets compliant with a network communication protocol to meet predetermined requirements for delivery thereof at the remote location;
determining at predetermined temporal intervals network performance indicators indicative of data throughput in the communication network as dictated by transmission procedures of the network communication protocol;
estimating value of the network data capacity from the network performance indicators;
retrieving the values of the encoding parameters assigned to the value of the estimated network capacity; and
encoding the structured data at a constant data rate corresponding to the encoding parameters.

19. The method as recited in claim 18, wherein the retrieving the values of the encoding parameters includes retrieving respective values of a pair of encoding parameters assigned to the value of the estimated network capacity.

20. The method as recited in claim 19, wherein the retrieving respective values of a pair of encoding parameters includes retrieving an input rate to the encoding operation and the constant data rate from the encoding operation.
